(19) United States
(12) Patent Application Publication
(10) Pub. No.: US 2026/0211259 A1
(43) Pub. Date: Jul. 23, 2026

(54) IMAGE STABILIZATION MECHANISM, AND LENS BARREL AND IMAGING DEVICE EQUIPPED WITH THE SAME

(71) Applicant: Panasonic Intellectual Property Management Co., Ltd., Osaka (JP)

(72) Inventors: Takayuki YAMAMOTO, Osaka (JP); Makoto UMEDA, Osaka (JP); Tatsuhiro ENOMOTO, Nara (JP); Naoki YOSHIKAWA, Osaka (JP)

(73) Assignee: Panasonic Intellectual Property Management Co., Ltd., Osaka (JP)

(21) Appl. No.: 19/452,246

(22) Filed: Jan. 17, 2026

(30) Foreign Application Priority Data
Jan. 20, 2025 (JP) 2025-007817

(51) Int. Cl. G02B 27/64; G03B 5/02; H04N 23/54; H04N 23/55; H04N 23/68

(52) U.S. Cl. CPC G02B 27/646; G03B 5/02; H04N 23/54; H04N 23/55; H04N 23/685; G03B 2205/0015; G03B 2205/0069

(57) ABSTRACT

The image stabilization mechanism 20 includes the fixed frame 22, the fixed frame 23, the lens frame 21, the balls 25a, 25b and the biasing spring 27. The lens frame 21 has an optical lens L3 and a coil 24a, 24b, is disposed so as to be sandwiched between the fixed frame 22, 23, and is movable with respect to the fixed frame 22, 23. The balls 25a are disposed in a state of being movable within a plane perpendicular to the optical axis direction, and that make contact with the fixed frame 22 and the lens frame 21. The balls 25b are disposed in a state of being movable within a plane perpendicular to the optical axis direction, and that make contact with the fixed frame 23 and the lens frame 21. The biasing spring 27 is latched at both ends to the fixed frame 22, 23, and biases, via the balls 25a, 25b, the fixed frame 22, 23 in the optical axis direction so as to sandwich the lens frame 21.

This application claims priority to Japanese Patent Application No. 2025-007817 filed on Jan. 20, 2025. The entire disclosure of Japanese Patent Application No. 2025-007817 is hereby incorporated herein by reference.

### BACKGROUND

### Technical Field

The present disclosure relates to an image stabilization mechanism installed in a lens barrel or a camera body, for example, and to a lens barrel and an imaging device equipped with this mechanism.

### Description of the Related Art

For example, Patent Literature 1 discloses an image stabilization mechanism that includes a fixed member, a movable unit that holds a correction lens, and a rotation restriction member, wherein a rolling member is made up of a plurality of first rolling balls and second rolling balls, and a biasing force is exerted by a biasing spring in the direction of bringing the fixed member and the rotation restriction member closer together.

Patent Literature 2 discloses a lens shift device that has: a movable member that holds a lens and is shifted within a plane perpendicular to the optical axis direction; a guide member that is provided between a fixed member and the movable member; three or more first balls that are sandwiched between the fixed member and the first guide member; three or more second balls that are sandwiched between the guide member and the movable member; a first ball holder for rotatably holding the first balls; a second ball holder for rotatably holding the second balls; a first groove portion that is provided at a position opposite the first ball holder with the first balls in between, and that is used for guiding the movable member in one direction via the guide member; a second groove portion that is provided at a position opposite the second ball holder with the second balls in between, and that is used for guiding the movable member in one direction perpendicular to the first groove portion; and an elastic member that generates a pressing force to hold the first and second balls.

### CITATION LIST

### Patent Literature

Patent Literature 1: JP 2015-11277 A
Patent Literature 2: JP H11-007051 A

### SUMMARY

### Problem to be Solved by the Invention

However, the following problem is encountered with the image stabilization mechanism disclosed in the above-mentioned Patent Literature 1.

With the image stabilization mechanism disclosed in the above-mentioned Patent Literature 1, the two ends of the biasing spring are latched to the fixed frame and the movable unit disposed opposite the fixed frame in the optical axis direction, respectively, so as to apply a biasing force (see FIG. 6). Therefore, when the amount of movement of the movable unit increases, it is necessary to lengthen the biasing spring in order to exert a constant force to the movable unit in the optical axis direction and in a plane perpendicular to the optical axis.

Also, with the lens shift device disclosed in Patent Literature 2, both sides of the movable member in the optical axis direction are supported via three first balls and three second balls. However, a leaf spring-like elastic member is configured to generate a pressing force that squeezes the first balls and the second balls, so the first balls and the second balls do not move. Accordingly, a problem is that this configuration cannot handle larger amounts of movement of the movable member.

It is an object of the present disclosure to provide an image stabilization mechanism in which rolling members disposed on both sides of a movable frame in the optical axis direction are able to move within a plane perpendicular to the optical axis direction, and in which a biasing member can be shortened, as well as a lens barrel and an imaging device equipped with this mechanism.

### Means for Solving Problem

The image stabilization mechanism according to the present disclosure has a first fixed frame, a second fixed frame, a movable frame, a first rolling member, a second rolling member, and a biasing member. The first fixed frame has a magnet or a coil. The second fixed frame is disposed at a position opposite the first fixed frame. The movable frame has an optical element and a coil or a magnet, is disposed so as to be sandwiched between the first fixed frame and the second fixed frame, and is movable with respect to the first fixed frame and the second fixed frame. The first rolling member is disposed between the first fixed frame and the movable frame in a state of being movable within a plane perpendicular to the optical axis direction of the optical element, and makes contact with the first fixed frame and the movable frame. The second rolling member is disposed between the second fixed frame and the movable frame in a state of being movable within a plane perpendicular to the optical axis direction, and makes contact with the second fixed frame and the movable frame. The biasing member is latched at both ends to the first fixed frame and the second fixed frame, and biases the first fixed frame and the second fixed frame in the optical axis direction so as to sandwich the movable frame via the first rolling member and the second rolling member.

### Effects

According to the image stabilization mechanism of the present disclosure, the rolling members disposed on both sides of the movable frame in the optical axis direction are able to move in a plane perpendicular to the optical axis direction, allowing the biasing member to be shorter.

### BRIEF DESCRIPTION OF THE DRAWINGS

FIG. 1 is an exploded oblique view of the configuration of a lens barrel including an OIS unit (image stabilization mechanism) according to an embodiment of the present disclosure;

FIG. 2 is an oblique view of the configuration of the OIS unit included in the lens barrel in FIG. 1;

FIG. 3 is an exploded oblique view of the configuration of the OIS unit in FIG. 2;

FIG. 4 is an oblique view showing a state in which a fixed frame on the subject side included in the OIS unit in FIG. 3 has been removed;

FIG. 5 is a front view of the OIS unit in FIG. 2, as seen from the subject side in the optical axis direction;

FIG. 6 is a cross-sectional view along the C-C line of the OIS unit shown in FIG. 5;

FIG. 7 is a front view of the configuration of the image stabilization mechanism included in the OIS unit in FIG. 2, as seen from the subject side in the optical axis direction;

FIG. 8 is a cross-sectional view along the D-D line of the image stabilization mechanism in FIG. 7;

FIG. 9 is a cross-sectional view along the E-E line of the image stabilization mechanism in FIG. 7;

FIG. 10 is a front view of the components surrounding the coil in the image stabilization mechanism in FIG. 7, as seen in the optical axis direction;

FIG. 11 is an overall oblique view of the configuration of a camera body including the image stabilization mechanism according to another embodiment of the present disclosure;

FIG. 12 is an exploded oblique view of the configuration of the camera body in FIG. 11; and

FIG. 13 is a front view of the components surrounding the coil in the image stabilization mechanism included in the camera body in FIG. 12, as seen in the optical axis direction.

### DETAILED DESCRIPTION OF THE EMBODIMENT

Embodiments will now be described in detail with reference to the accompanying drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

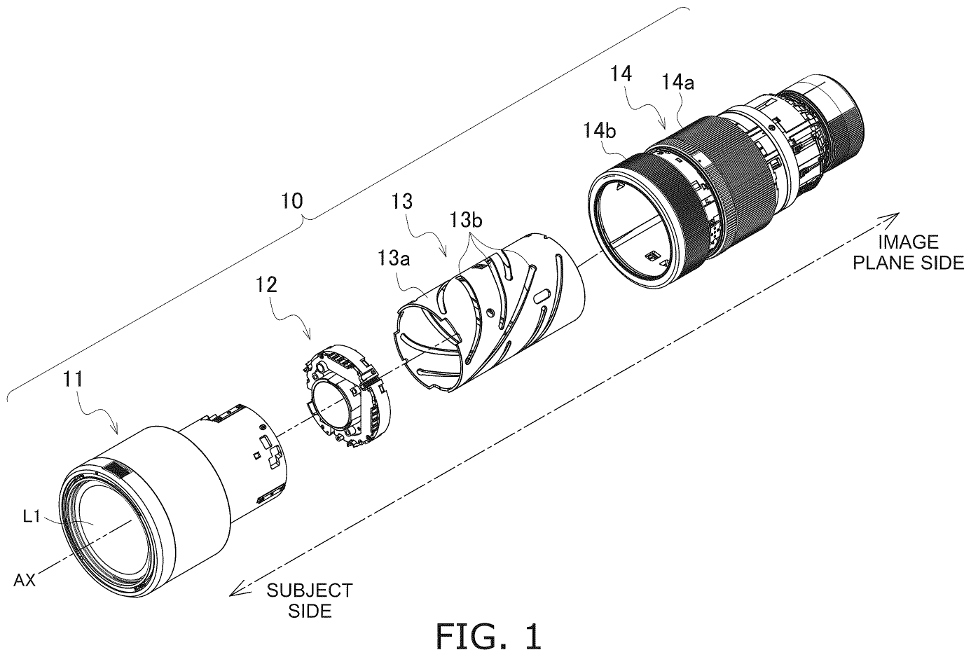

A lens barrel 10 equipped with an image stabilization mechanism 20 according to an embodiment of the present disclosure will now be described with reference to FIGS. 1 to 10.

### (1) Configuration of Lens Barrel 10

The lens barrel 10 according to this embodiment is removably attached to a camera body (not shown), and as shown in FIG. 1, is provided with a first lens group unit 11, an OIS (optical image stabilizer) unit 12, a cam frame 13, and an exterior unit 14.

As shown in FIG. 1, the first lens group unit 11 is a substantially cylindrical member that is disposed the closest to the subject in the optical axis AX direction of all the components constituting the lens barrel 10, and holds the first lens group L1 on its inner peripheral surface side.

The OIS (optical image stabilizer) unit 12 is configured to include an image stabilization mechanism 20 (discussed below), and is provided with a lens frame (movable frame) 21, fixed frames (first and second fixed frames) 22 and 23, and so on.

The detailed configuration of the image stabilization mechanism 20 included in the OIS unit 12 will be discussed below.

As shown in FIG. 1, the cam frame 13 is disposed on the outer peripheral surface side of the OIS unit 12, and has a substantially cylindrical main body portion 13a and a plurality of cam grooves 13b formed in the main body portion 13a. Cam pins (not shown) on the exterior unit 14 move in a state of being engaged with the cam grooves 13b.

As shown in FIG. 1, the exterior unit 14 is a substantially cylindrical member that constitutes the outer portion of the lens barrel 10, and a circular zoom ring 14a, a focus ring 14b, and so forth are attached to its outer peripheral surface in a state of being rotatable in the circumferential direction.

### (2) Configuration of Image Stabilization Mechanism 20

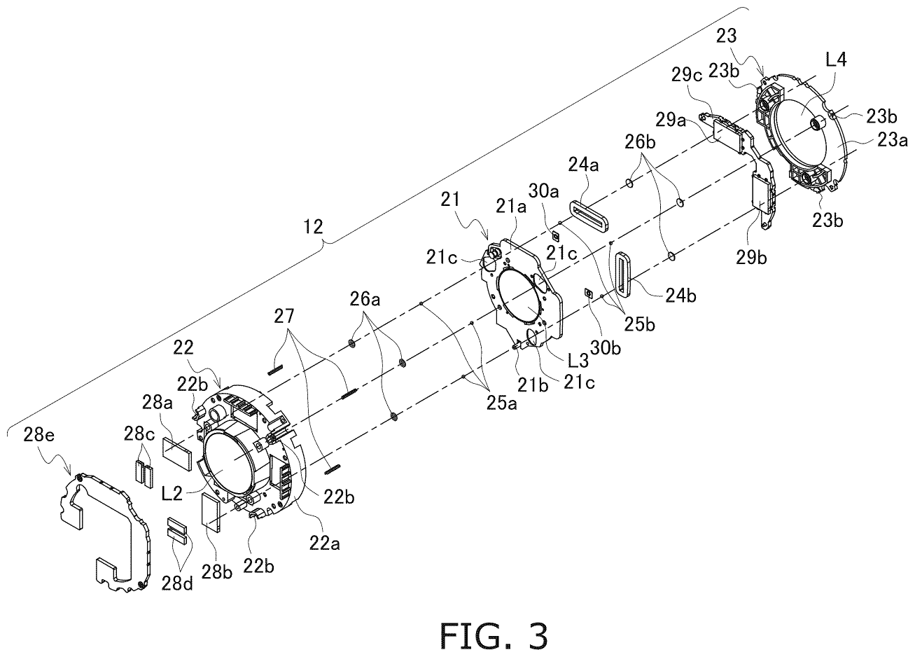

The image stabilization mechanism 20 according to this embodiment employs a so-called moving coil system in which coils 24a and 24b (see FIG. 3) are disposed on a lens frame 21 that is able to move back and forth in the optical axis direction.

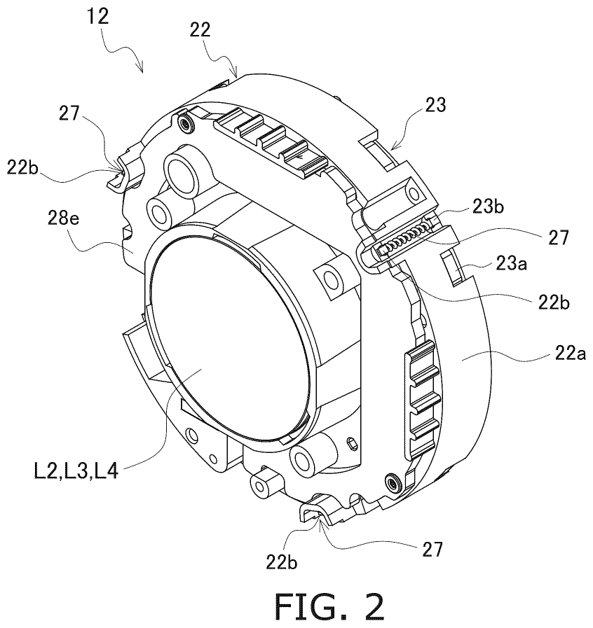

The image stabilization mechanism 20 controls so as to move of the lens frame 21 in the opposite direction from direction of detected camera shake. As shown in FIGS. 2 and 3, the image stabilization mechanism 20 includes a lens frame (movable frame) 21 that holds the optical lens L2, a fixed frame (first fixed frame) 22, a fixed frame (second fixed frame) 23, coils 24a and 24b, three balls (first rolling members) 25a, three balls (second rolling members) 25b, sheet metal members 26a and 26b, three biasing springs (biasing members) 27, magnets 28a and 28b, magnets 28c and 28d, a back yoke (magnetic plate) 28e, magnets 29a and 29b, a back yoke (magnetic plate) 29c, and position detection elements 30a and 30b.

As shown in FIGS. 2 and 3, the lens frame 21 is a substantially flat member that holds the optical lens (optical element) L3 at its center, and is attached in a state of being sandwiched between the fixed frames 22 and 23 and being able to move with respect to the fixed frames 22 and 23. The lens frame 21 is supported at three points in the optical axis direction on both sides of the optical lens L3 by the balls 25a and 25b. When current is passed through the coils 24a and 24b (discussed below), the lens frame 21 is driven so as to move in the opposite direction from the direction of camera shake detected by a gyro sensor (not shown) or the like.

Also, as shown in FIG. 3, the lens frame 21 has a first rolling surface (step portion 21c) on the subject side in the optical axis direction, where the balls 25a roll between the lens frame 21 and the fixed frame 22, and a second rolling surface (step portion 21c) on the opposite side from the subject in the optical axis direction, where the balls 25b roll between the lens frame 21 and the fixed frame 23.

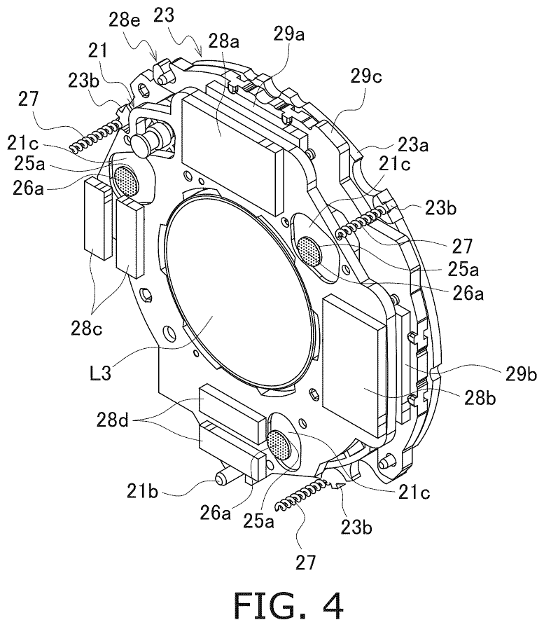

Furthermore, as shown in FIGS. 3 and 4, the lens frame 21 has a main body portion 21a, a rotation shaft 21b, and step portions 21c that are formed by recessing part of the surface of the main body portion 21a that is perpendicular to the optical axis direction, and in which the first rolling surface and the second rolling surface are disposed in a rollable state.

The main body portion 21a is a substantially disk-shaped member, and holds the optical lens L3 in an opening provided in its center.

The rotation shaft 21b is a rod-shaped member disposed in the optical axis direction, and serves as the center of rotation when the lens frame 21 is controlled to rotate in the pitch direction with respect to the fixed frame 22.

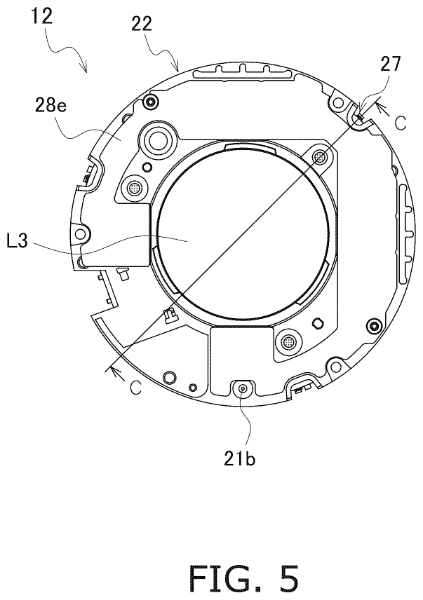

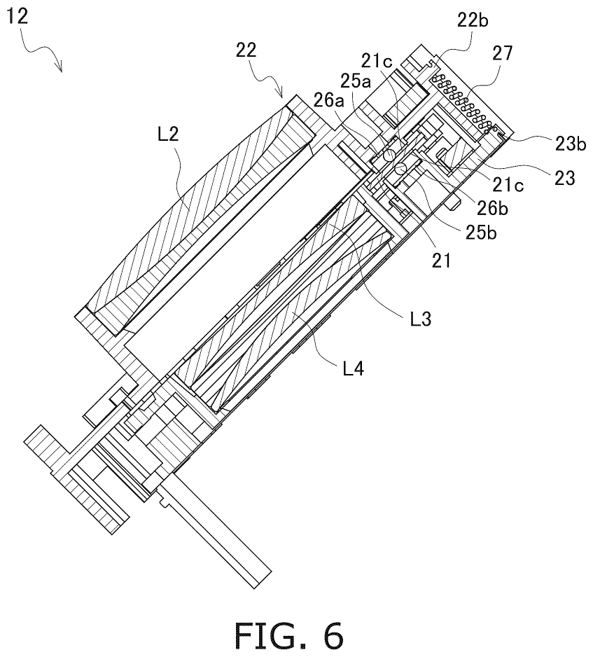

As shown in FIGS. 5 and 6, the step portions 21c (first and second rolling surfaces) are provided on both sides of the lens frame 21 in the optical axis direction, and are provided at three locations along the circumferential direction centered on the optical axis. Also, the step portions 21c (first and second rolling surfaces) have a surface area that is greater than the diameter of the balls 25a and 25b, and hold the balls 25a and 25b in a state of being able to move in a plane perpendicular to the optical axis.

The first rolling surface and the second rolling surface provided on both sides of the lens frame 21 in the optical axis direction are constituted by sheet metal members provided to the step portions 21c, and the balls 25a and 25b roll on the surface of the sheet metal members.

As shown in FIG. 3, the fixed frame (first fixed frame) 22 is a substantially cylindrical member that holds the optical lens L2, and is disposed at a position adjacent to the lens frame 21 on the subject side in the optical axis direction. The fixed frame 22 is provided with magnets 28a and 28b and magnets 28c and 28d as shown in FIG. 4.

As shown in FIGS. 3 and 4, the fixed frame 22 has third rolling surfaces (sheet metal members 26a) on which the balls 25a are rolled between the fixed frame 22 and the lens frame 21. The third rolling surfaces are formed by sheet metal members 26a.

As shown in FIG. 3, the fixed frame 22 has a substantially cylindrical main body portion 22a and three latching portions 22b provided to the outer peripheral portion of the main body portion 22a.

The three latching portions 22b latch the ends of the three biasing springs 27 (discussed below) on the subject side in the optical axis direction.

As shown in FIG. 3, the fixed frame (second fixed frame) 23 is a substantially cylindrical member that holds the optical lens L4, and is disposed at a position adjacent to the lens frame 21 on the opposite side from the subject in the optical axis direction. The fixed frame 23 is provided with the magnets 29a and 29b shown in FIG. 4.

As shown in FIGS. 3 and 4, the fixed frame 23 has fourth rolling surfaces (sheet metal members 26b) on which the balls 25b are rolled between the fixed frame 23 and the lens frame 21. The fourth rolling surfaces are constituted by the sheet metal members 26b.

As shown in FIG. 3, the fixed frame 23 has a substantially disk-shaped main body portion 23a, and three latching portions 23b that are provided on the outer peripheral portion of the main body portion 23a.

The three latching portions 23b latch the ends of the three biasing springs 27 (discussed below) on the opposite side from the subject in the optical axis direction.

As shown in FIG. 3, etc., the coils 24a and 24b are provided to the lens frame 21, and when current is passed through the coils, the magnetic force of the adjacently-disposed magnets 28a and 28b and magnets 29a and 29b generates a Lorentz force in the desired direction (the opposite direction from the camera shake direction). This allows the lens frame 21 to be moved with respect to the fixed frames 22 and 23.

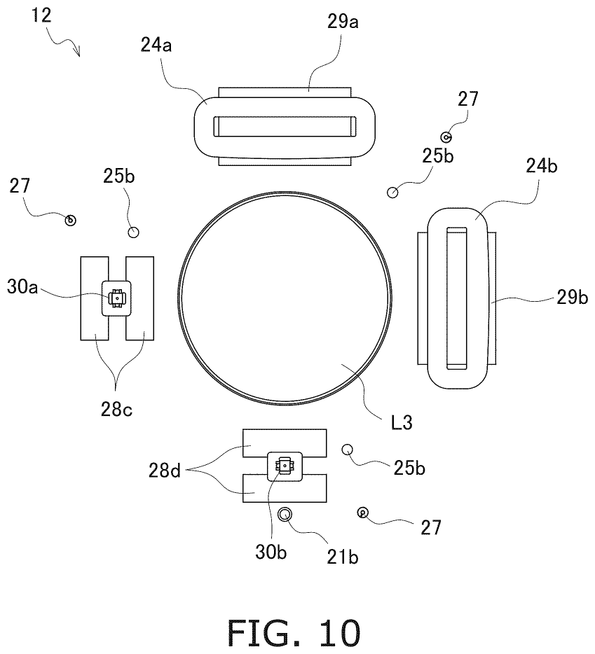

The coil 24a is energized when camera shake is detected during imaging, and is controlled to move the lens frame 21 in a plane perpendicular to the optical axis. When the coil 24a is energized to drive the lens frame 21 to the rectilinear movement side (yaw side), a Lorentz force is generated by the magnetic force of the magnets 28a and 29a (see FIG. 10) disposed opposite each other on the fixed frames 22 and 23 side.

The coil 24b is energized when camera shake is detected during imaging, and is controlled to move the lens frame 21 in a plane perpendicular to the optical axis. When the coil 24b is energized to drive the lens frame 21 to the rotation side (pitch side), a Lorentz force is generated by the magnetic force of the magnets 28b and 29b (see FIG. 10) disposed opposite each other on the fixed frames 22 and 23 side.

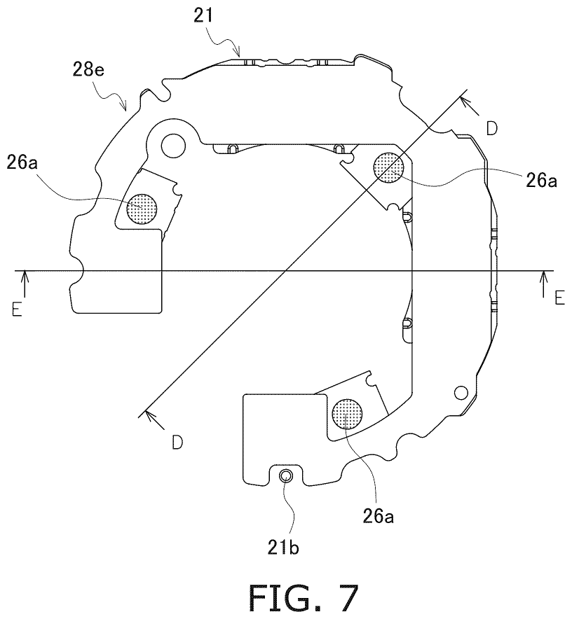

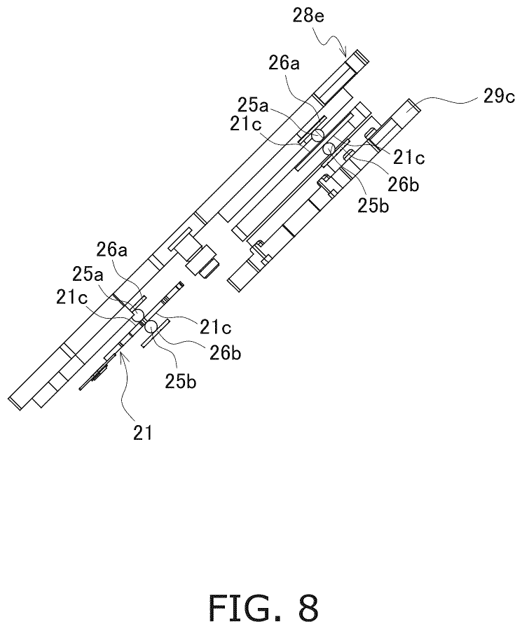

As shown in FIG. 3, etc., the three balls (first rolling members) 25a are disposed between the fixed frame 22 and the lens frame 21 in a state of being able to move in a plane perpendicular to the optical axis of the optical lens L3, and support the lens frame 21 relative to the fixed frame 22. As shown in FIGS. 7 and 8, the three balls 25a come into contact with the sheet metal members 26a provided to the fixed frame 22 and the step portions 21c (first rolling surfaces) on the lens frame 21 side.

As shown in FIG. 3, etc., the three balls (second rolling members) 25b are disposed between the lens frame 21 and the fixed frame 23 in a state of being able to move in a plane perpendicular to the optical axis of the optical lens L3, and support the lens frame 21 relative to the fixed frame 23. As shown in FIGS. 7 and 8, the three balls 25b come into contact with the sheet metal members 26b provided to the fixed frame 23 and the step portions 21c (second rolling surfaces) on the lens frame 21 side.

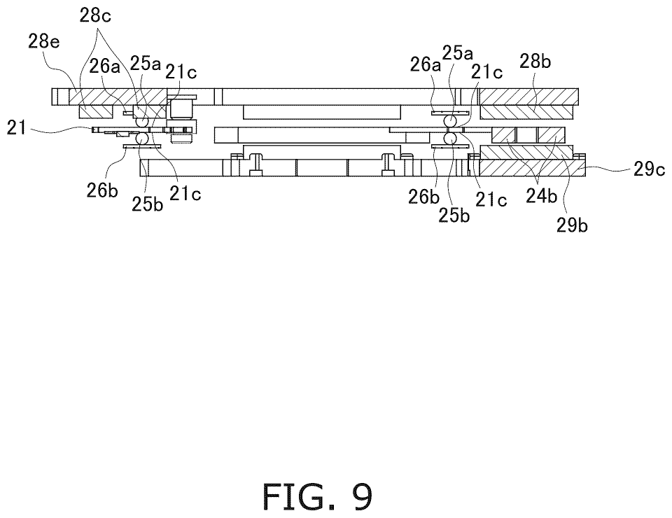

That is, as shown in FIG. 9, the balls 25a and 25b support the two sides of the lens frame 21 in the optical axis direction.

The position adjustment of the balls 25a and 25b on the first rolling surfaces and the second rolling surfaces is performed when the power is ON, for example.

This allows the initial positions of the balls 25a and 25b that can roll on the first rolling surfaces and the second rolling surfaces (step portions 21c) of the lens frame 21 to be adjusted when the power is ON.

As shown in FIG. 3, etc., the sheet metal members 26a are substantially disk-shaped members that are provided to the fixed frame 22. The sheet metal members 26a make contact with the fixed frame 22 so that the three balls 25a supporting the lens frame 21 are able to roll.

As shown in FIG. 3, etc., the sheet metal members 26b are substantially disk-shaped members that are provided to the fixed frame 23. The sheet metal members 26b make contact with the fixed frame 23 in a state in which the three balls 25b supporting the lens frame 21 are able to roll.

As shown in FIGS. 2 and 3, the three biasing springs (biasing members) 27 are latched at both ends to latching portions 22b provided on the outer peripheral portion of the fixed frame 22 and to latching portions 23b provided on the outer peripheral portion of the fixed frame 23. The biasing springs 27 bias the fixed frame 22 and the fixed frame 23 via the balls 25a and 25b in the direction of moving them closer together in the optical axis direction so as to sandwich the lens frame 21. That is, the biasing springs 27 exert a force that sandwiches the lens frame 21 between the fixed frames 22 and 23 in the optical axis direction (a force that attracts the fixed frames 22 and 23 to each other).

As shown in FIG. 3, etc., the magnets 28a and 28b are attached between the subject-side surface of the fixed frame 22 in the optical axis direction and the back yoke 28e, and are provided to drive the lens frame 21 in a plane perpendicular to the optical axis.

As shown in FIG. 3, etc., the magnets 28c and 28d are provided to the back yoke 28e that is fixed to the fixed frame 22. As shown in FIG. 10, the magnets 28c and 28d are provided for detecting the positions of the lens frame 21 on the rectilinear movement side (yaw side) and the rotational movement side (pitch side), and are disposed at positions opposing the position detection elements 30a and 30b, respectively.

As shown in FIGS. 3 and 9, the back yoke (magnetic plate) 28e is attached to the fixed frame 22 in a state in which the magnets 28a and 28b and the magnets 28c and 28d are respectively disposed on the surface on the opposite side from the subject in the optical axis direction.

The magnets 29a and 29b are fixed to a back yoke (magnetic plate) 29c attached to the fixed frame 23. The magnets 29a and 29b are disposed at positions opposing the coils 24a and 24b, respectively, disposed on the lens frame 21, as shown in FIG. 10.

As shown in FIG. 3, etc., the back yoke (magnetic plate) 29c has the magnets 29a and 29b disposed on its surface on the subject side in the optical axis direction.

The position detection elements 30a and 30b are disposed on the lens frame 21 in order to detect the relative position of the lens frame 21 with respect to the fixed frames 22 and 23 when the lens frame 21 is driven by the image stabilization mechanism 20.

As shown in FIG. 3, the position detection element 30a is disposed at a position opposite the magnets 28c for position detection on the rectilinear movement side (yaw side), and detects the relative position of the lens frame 21 on the rectilinear movement side (yaw side) with respect to the fixed frames 22 and 23.

As shown in FIG. 3, the position detection element 30b is disposed at a position opposite the position detection magnets 28d on the rotation side (pitch side), and detects the relative position of the lens frame 21 on the rotation side (pitch side) with respect to the fixed frames 22 and 23.

### Main Features

As shown in FIG. 3, etc., the image stabilization mechanism 20 of this embodiment includes the fixed frame 22, the fixed frame 23, the lens frame 21, the balls 25a and 25b, and the biasing spring 27. The fixed frame 22 has the magnets 28a and 28b. The fixed frame 23 is disposed at a position opposite the fixed frame 22. The lens frame 21 has the optical lens L3 and the coils 24a and 24b, is disposed so as to be sandwiched between the fixed frames 22 and 23, and is able to move with respect to the fixed frames 22 and 23. The balls 25a are disposed between the fixed frame 22 and the lens frame 21 in a state of being able to move within a plane perpendicular to the optical axis direction of the optical lens L3, and make contact with the fixed frame 22 and the lens frame 21. The balls 25b are disposed between the fixed frame 23 and the lens frame 21 in a state of being able to move within a plane perpendicular to the optical axis direction, and make contact with the fixed frame 23 and the lens frame 21. The biasing springs 27 are latched at both ends to the fixed frames 22 and 23, and bias the fixed frames 22 and 23 in the optical axis direction via the balls 25a and 25b so as to sandwich the lens frame 21 in between.

Consequently, the lens frame 21 is held between the fixed frames 22 and 23 in a state of being drivable in a plane perpendicular to the optical axis, via the balls 25a and 25b. The biasing springs 27 that exert a biasing force in the direction of attracting the fixed frames 22 and 23 toward each other is not latched to the lens frame 21, so there is no need for the biasing springs to have a length that takes into account the movement of the lens frame 21 in a plane perpendicular to the optical axis, and the biasing springs 27 can be shorter than in the past.

As a result, the balls 25a and 25b disposed on both sides of the lens frame 21 in the optical axis direction are able to move in a plane perpendicular to the optical axis direction, and the biasing springs 27 can be shorter.

Also, since the biasing springs 27 take up less space than in the past, the image stabilization mechanism 20 will also take up less space in the radial direction.

Furthermore, in the past, when an imaging device was in its normal position (landscape orientation), biasing springs were disposed to counteract the weight of the lens frame so that the optical lens of the lens frame would be at the center of the optical axis. Therefore, when imaging in something other than the normal orientation, the thrust force of the lens frame was needed in addition to the spring force corresponding to the weight of the lens frame, so there was a risk that a higher thrust (higher power consumption) would be needed than in the normal orientation.

With the image stabilization mechanism 20 of this embodiment, one end of the biasing springs 27 is not latched to the lens frame 21, so regardless of the imaging orientation of the imaging device, there is no need to compensate for changes in the biasing force of the biasing springs 27 with thrust. This means that the image stabilization mechanism 20 will consume less power than a conventional mechanism.

Also, since the maximum amount of movement of the lens frame 21 in a plane perpendicular to the optical axis (the movement in the worst case, at the end in the XY plane perpendicular to the optical axis) is smaller than in the past, the maximum output is reduced, and the image stabilization mechanism 20 can have a smaller power supply capacity.

### Other Embodiments

An embodiment of the present disclosure was described above, but the present disclosure is not limited to or by the above embodiment, and various modifications are possible without departing from the gist of the disclosure.
(A)

In the above embodiment, an example was given of a moving-coil image stabilization mechanism 20 in which the coils 24a and 24b were disposed on the lens frame (movable frame) 21 side, and the magnets 28a and 28b and the magnets 29a and 29b were disposed on the fixed frames 22 and 23 side, respectively. However, the present disclosure is not limited to this.

For example, the present disclosure may instead be a moving-magnet image stabilization mechanism in which magnets are disposed on the movable frame side and coils are disposed on the fixed frame side.
(B)

In the above embodiment, an example was given in which the optical lens L3 was used as the optical element held by the lens frame 21. However, the present disclosure is not limited to this.

For example, the configuration may be such that an imaging element, instead of a lens, is used as the optical element held by the movable frame.

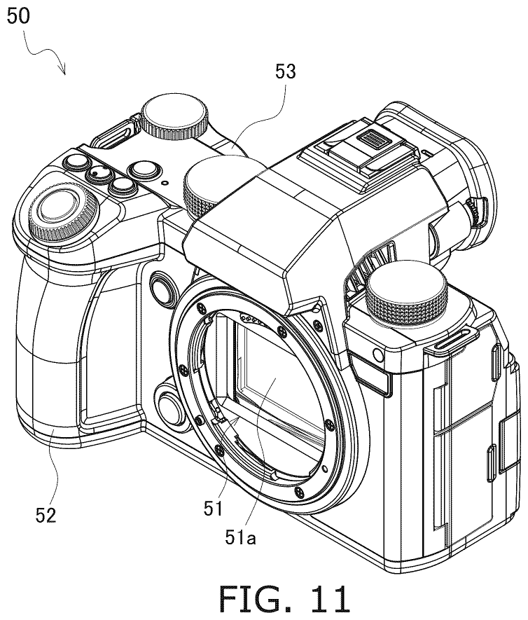

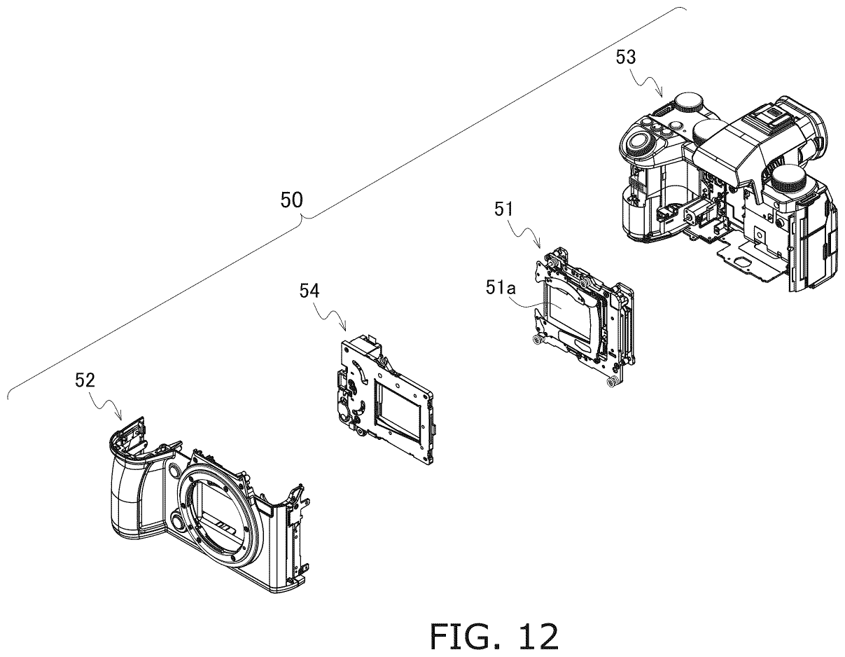

More specifically, as shown in FIGS. 11 and 12, a camera body 50 of the imaging device includes a BIS (in-body image stabilizer) unit 51, an exterior unit 52, an exterior unit 53, and a shutter unit 54.

The BIS (in-body image stabilizer) unit 51 includes a movable frame corresponding to the lens frame 21 in Embodiment 1 above, fixed frames 22 and 23, coils 24a and 24b, three balls (first rolling members) 25a, three balls (second rolling members) 25b, sheet metal members 26a and 26b, three biasing springs (biasing members) 27, magnets 28a and 28b, magnets 28c and 28d, a back yoke (magnetic plate) 28e, magnets 29a and 29b, a back yoke (magnetic plate) 29c, and members corresponding to the position detection elements 30a and 30b.

The imaging element (optical element) 51a is held by a movable frame, and converts an image of the subject formed by light incident from the subject side via an optical lens into image data.

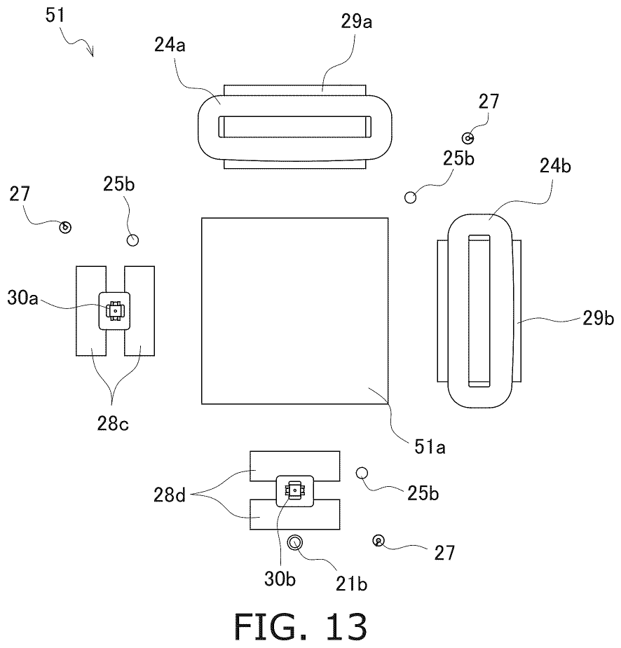

As shown in FIG. 13, the position of the movable frame holding the imaging element 51a in a plane perpendicular to the optical axis is adjusted by passing a current through the coils 24a and 24b that are disposed opposite the magnets 28a and 29a and the magnets 28b and 29b, which is similar to the image stabilization mechanism 20 of the OIS unit 12 in Embodiment 1 given above.

As shown in FIG. 13, the movable frame holding the imaging element 51a is disposed at a position opposite the magnets 28c and 28d for position detection on the rectilinear movement side (yaw side) and the rotational side (pitch side) by position detection elements 30a and 30b, and the relative positions of the movable frame on the rectilinear movement side (yaw side) and rotational side (pitch side) with respect to the fixed frames 22 and 23 are detected, which is similar to the image stabilization mechanism 20 of the OIS unit 12 in Embodiment 1 given above.

Consequently, even when the imaging element 51a is used as the optical element instead of an optical lens, the same effect can be obtained in Embodiment 1.
(C)

In the above embodiment, an example was given in which sheet metal members were provided to the step portions 21c provided on both sides of the lens frame 21 in the optical axis direction as the rolling surfaces of the balls 25a and 25b. However, the present disclosure is not limited to this.

For example, the configuration may be such that there are no sheet metal members on either side of the lens frame (movable frame) in the optical axis direction.

Also, even when sheet metal members are used, the configuration may be such that balls (rolling members) roll on sheet metal members provided in a portion where there is no step portion.
(D)

In the above embodiment, an example was given in which three each of the balls 25a and 25b were used as rolling members that supported the lens frame 21 relative to the fixed frames 22 and 23. However, the present disclosure is not limited to this.

For example, the number of rolling members is not limited to three, and may instead be four or more.
(E)

In the above embodiment, an example was given in which the configuration of the present disclosure was applied to the lens barrel 10 that was removably attached to the camera body. However, the present disclosure is not limited to this.

For example, the configuration of the present disclosure may be applied to a lens barrel that is permanently fixed to a camera body.

### Addenda

The above description of the embodiments discloses the following techniques.

### Technique 1

The image stabilization mechanism according to Technique 1 comprises:
a first fixed frame that has a magnet or a coil;
a second fixed frame that is disposed at a position opposite the first fixed frame;
a movable frame that has an optical element and a coil or a magnet, is disposed so as to be sandwiched between the first fixed frame and the second fixed frame, and is movable with respect to the first fixed frame and the second fixed frame;
a first rolling member that is disposed between the first fixed frame and the movable frame in a state of being movable within a plane perpendicular to the optical axis direction of the optical element, and that makes contact with the first fixed frame and the movable frame;
a second rolling member that is disposed between the second fixed frame and the movable frame in a state of being movable within a plane perpendicular to the optical axis direction, and that makes contact with the second fixed frame and the movable frame; and
a biasing member that is latched at both ends to the first fixed frame and the second fixed frame, and which biases, via the first rolling member and the second rolling member, the first fixed frame and the second fixed frame in the optical axis direction so as to sandwich the movable frame.

### Technique 2

The image stabilization mechanism according to Technique 2 is the image stabilization mechanism according to Technique 1,
wherein the movable frame has a first rolling surface on which the first rolling member rolls between the first rolling surface and the first fixed frame on the subject side in the optical axis direction, and a second rolling surface on which the second rolling member rolls between the second rolling surface and the second fixed frame on the opposite side from the subject in the optical axis direction.

### Technique 3

The image stabilization mechanism according to Technique 3 is the image stabilization mechanism according to Technique 2,
wherein the first rolling surface and the second rolling surface are constituted by sheet metal members.

### Technique 4

The image stabilization mechanism according to the Technique 4 is the image stabilization mechanism according to Technique 2 or 3,
wherein the movable frame further has a main body portion, and a step portion that is formed by recessing part of a surface of the main body portion that is perpendicular to the optical axis direction, and on which the first rolling surface and the second rolling surface are disposed in a rollable state.

### Technique 5

The image stabilization mechanism according to Technique 5 is the image stabilization mechanism according to Technique 2 or 3,
wherein the first rolling surface and the second rolling surface are provided at three locations along the circumferential direction centered on the optical axis, on both sides of the movable frame in the optical axis direction.

### Technique 6

The image stabilization mechanism according to Technique 6 is the image stabilization mechanism according to Technique 2 or 3,
wherein the first fixed frame and the second fixed frame each have a third rolling surface and a fourth rolling surface on which the first rolling members and the second rolling members are rolled.

### Technique 7

The image stabilization mechanism according to Technique 7 is the image stabilization mechanism according to Technique 6,
wherein the third rolling surface and the fourth rolling surface are constituted by sheet metal members.

### Technique 8

The image stabilization mechanism according to Technique 8 is the image stabilization mechanism according to any of Techniques 1 to 7,
wherein the optical element is a lens.

### Technique 9

The image stabilization mechanism according to Technique 9 is the image stabilization mechanism according to any of Techniques 1 to 7,
wherein the optical element is an imaging element.

### Technique 10

The lens barrel according to Technique 10 comprises:
the image stabilization mechanism according to any of Techniques 1 to 9; and
a lens frame that holds a lens.

### Technique 11

The imaging device according to Technique 11 comprises:
the lens barrel according to Technique 10; and
a camera body to which the lens barrel is attached and which has an imaging element.

### INDUSTRIAL APPLICABILITY

The image stabilization mechanism of the present disclosure exhibits the effect that the rolling members disposed on both sides of the movable frame in the optical axis direction are able to move in a plane perpendicular to the optical axis direction, allowing the biasing members to be shorter, and as such can be broadly applied to a variety of optical devices equipped with an image stabilization mechanism.

### REFERENCE SIGNS LIST

10 lens barrel
11 first lens group unit
12 OIS unit
13 cam frame
13a main body portion
13b cam groove
14 exterior unit
14a zoom ring
14b focus ring
20 image stabilization mechanism
21 lens frame (movable frame)
21a main body portion
21b rotation shaft
21c step portion (first rolling surface, second rolling surface)
22 fixed frame (first fixed frame)
22a main body portion
22b latching portion
23 fixed frame (second fixed frame)
23a main body portion
23b latching portion
24a, 24b coils
25a ball (first rolling member)
25b ball (second rolling member)
26a sheet metal member (third rolling surface)
26b sheet metal member (fourth rolling surface)
27 biasing spring (biasing member)
28a, 28b magnets
28c, 28d magnets
28e back yoke (magnetic plate)
29a, 29b magnets
29c back yoke (magnetic plate)
30a, 30b position detection elements
50 camera body
51 BIS unit
51a imaging element (optical element)
52 exterior unit
53 exterior unit
54 shutter unit
L1 first lens group
L2 optical lens
L3 optical lens (optical element)
L4 optical lens

What is claimed is:

1. An image stabilization mechanism, comprising:
a first fixed frame that has a magnet or a coil;
a second fixed frame that is disposed at a position opposite the first fixed frame;
a movable frame that has an optical element and a coil or a magnet, is disposed so as to be sandwiched between the first fixed frame and the second fixed frame, and is movable with respect to the first fixed frame and the second fixed frame;
a first rolling member that is disposed between the first fixed frame and the movable frame in a state of being movable within a plane perpendicular to an optical axis direction of the optical element, and that makes contact with the first fixed frame and the movable frame;
a second rolling member that is disposed between the second fixed frame and the movable frame in a state of being movable within a plane perpendicular to the optical axis direction, and that makes contact with the second fixed frame and the movable frame; and
a biasing member that is latched at both ends to the first fixed frame and the second fixed frame, and which is configured to bias, via the first rolling member and the second rolling member, the first fixed frame and the second fixed frame in the optical axis direction so as to sandwich the movable frame.

2. The image stabilization mechanism according to claim 1,
wherein the movable frame has a first rolling surface on which the first rolling member rolls between the first rolling surface and the first fixed frame on a side of a subject in the optical axis direction, and a second rolling surface on which the second rolling member rolls between the second rolling surface and the second fixed frame on an opposite side from the subject in the optical axis direction.

3. The image stabilization mechanism according to claim 2,
wherein the first rolling surface and the second rolling surface are constituted by sheet metal members.

4. The image stabilization mechanism according to claim 2,
wherein the movable frame further has a main body portion, and a step portion that is formed by recessing part of a surface of the main body portion that is perpendicular to the optical axis direction, and on which the first rolling surface and the second rolling surface are disposed in a rollable state.

5. The image stabilization mechanism according to claim 2,
wherein the first rolling surface and the second rolling surface are provided at three locations along a circumferential direction centered on the optical axis, on both sides of the movable frame in the optical axis direction.

6. The image stabilization mechanism according to claim 2,
wherein the first fixed frame and the second fixed frame each have a third rolling surface and a fourth rolling surface on which the first rolling members and the second rolling members are rolled.

7. The image stabilization mechanism according to claim 6,
wherein the third rolling surface and the fourth rolling surface are constituted by sheet metal members.

8. The image stabilization mechanism according to claim 1,
wherein the optical element is a lens.

9. The image stabilization mechanism according to claim 1,
wherein the optical element is an imaging element.

10. A lens barrel, comprising:
the image stabilization mechanism according to claim 1; and
a lens frame that holds a lens.

11. An imaging device, comprising:
the lens barrel according to claim 10; and
a camera body to which the lens barrel is attached and which has an imaging element.
